(19) United States
(12) Patent Application Publication
(10) Pub. No.: US 2007/0109617 A1
(43) Pub. Date: May 17, 2007

(54) Viewing angle enhancement for holographic displays

(76) Inventors: Adrian James Cable, Cambridge (GB); Edward Buckley, Cambridge (GB); Nicholas Alexander Lawrence, Cambridge (GB)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 10/582,818

(22) PCT Filed: Dec. 14, 2004
(86) PCT No.: PCT/GB04/05255

§ 371 Date: Jan. 25, 2007

(30) Foreign Application Priority Data
Dec. 15, 2003 (GB) 0329014.5

(51) Int. Cl. G03H 1/08

(52) U.S. Cl. 359/9

(57) ABSTRACT

A holographic display has a pixellated (101, 102, 103) hologram display device (100) with a predetermined resolution and a pixellated (121-126) phase mask (120) arranged such that holograms displayed on the SLM (100) are viewed through the phase mask, wherein the phase mask has a resolution higher than the predetermined resolution.

The present invention relates to a holographic display and a method of increasing the viewing angle of a hologram on a pixellated hologram display device

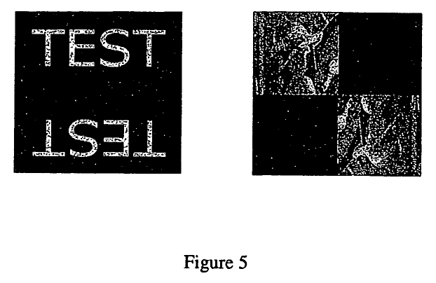

A well known problem with holographic displays is that of viewing angle, which is particularly relevant to 3D information display. Wide viewing angle requires very small pixels in the display, all of which must be individually addressable, resulting in difficulties in manufacture and in the bandwidth required to drive such a device.

Where binary phase holographic systems (both 2D and 3D) are used a further problem is the presence of a conjugate image in the replay field (see FIG. 5 herein).

It is an object of embodiments of the present invention to address one or both of these issues.

According to one aspect of the invention there is provided a holographic display comprising a pixellated hologram display device having a predetermined resolution and a pixellated phase mask arranged such that holograms displayed on the SLM are viewed through the phase mask, wherein the phase mask has a resolution higher than the predetermined resolution.

In an embodiment, the display comprises a pixellated hologram display device having a predetermined resolution and a pixellated phase mask arranged such that holograms displayed on the SLM are viewed through the phase mask, wherein the phase mask co-operates with the SLM such that the repeating pattern of holographic elements has a higher resolution than the predetermined resolution.

The hologram display device may be arranged to display binary phase holograms and the phase mask have four phase levels The display may be constructed and arranged to operate at a given optical wavelength, and taking one of the phase levels as a reference, the others provide respective phase shifts of π/2, π and 3π/2 at the given wavelength.

The hologram display device may be arranged to display four phase holograms and the phase mask has two phase levels.

The hologram display device may comprises an SLM.

In a second aspect the invention relates to a method of increasing the viewing angle of a hologram on a pixellated hologram display device having a predetermined resolution, the method comprising disposing a pixellated phase mask with respect to the pixellated hologram display device for viewing the hologram, wherein the resolution of the pixellated phase mask is greater than that of the pixellated hologram display device.

In a further aspect the invention relates to a method of viewing a pixellated hologram, the pixels of the hologram having a predetermined resolution, comprising viewing the hologram through a pixellated phase mask, wherein the resolution of the pixellated phase mask is greater than that of the pixellated hologram.

Exemplary embodiments of the invention will new be described by way of example only with respect to the attached drawings in which:

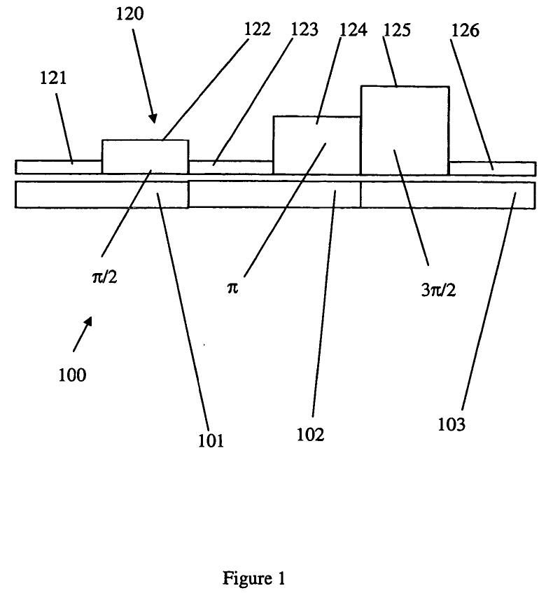

FIG. 1 shows a partial cross-sectional view through a holographic display device embodying the invention;

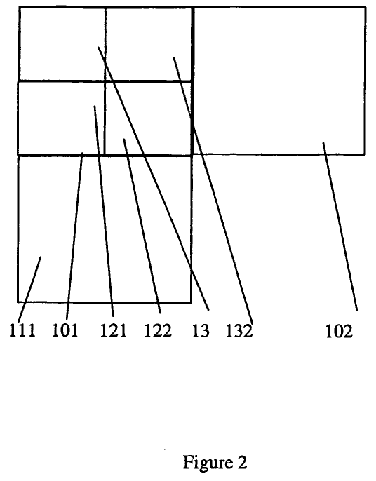

FIG. 2 shows a top elevation of the holographic display device of FIG. 1;

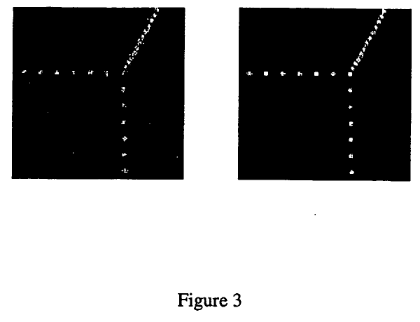

FIG. 3 shows comparative results of two test simulations demonstrating that by use of the invention viewing angle can be increased;

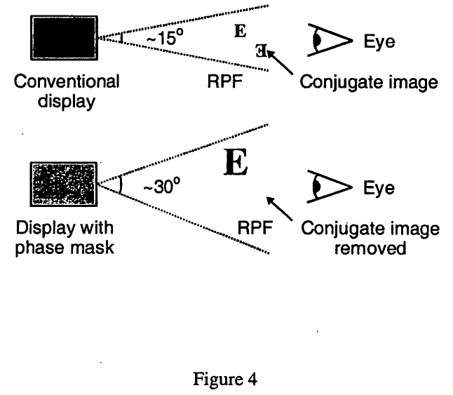

FIG. 4 shows the results of an embodiment of the invention using a binary phase SLM; and

FIG. 5 shows the artefact of conjugate image of a binary phase SLM.

Referring now to FIG. 2, an embodiment of the invention which uses a ferro-electric liquid crystal spatial light modulator (100) as its display device will now be described. It will be understood that other binary phase SLMs can be substituted for a FELC SLM. Moreover the use of a binary phase SLM is not fundamental to the invention in its broadest aspect, as the viewing angle of SLMs in general may be increased by use of the invention

Typical SLMs that may be used include ferroelectric SLMs, nematic SLMs and OASLMs (optically-addressed spatial light modulators), and those using electroclinic, pi-cells, flexoelectric, antiferroelectric, ferrielectric, V-shaped switching cells, and guest-host dye cells. Non-liquid crystal technologies such as OLED displays, vacuum fluorescent displays, electroluminescent displays, MEMS devices such as DMDs, are also applicable.

As seen in FIG. 2, the SLM has plural image pixels (101-103) of which three are shown. As seen in FIG. 3, the pixels (101,103,111) are arranged in a regular 2-D array. An actual SLM has pixels amounting to several hundred pixels square. Rectangular arrays and arrays of other shapes may also be used.

Circuitry for addressing the pixels, and other layers such as electrode layers will be present but are not shown for ease of explanation. It will be understood that in the present embodiment the liquid crystal material is continuous across the part of the SLM shown, and that the designation of pixels corresponds to electrode arrangements to which field may be applied to cause the relevant volume of LC material to adopt a different orientation to the adjacent such volume.

A four-level phase mask (120) with greater resolution than that of the base hologram, of which the greatest resolution corresponds to the underlying, is disposed over and above the SLM (100). The phase mask is typically of plastic, and is random in that each area of the mask has an equal probability of each of the four levels. The mask may be physically on the SLM or disposed above it.

As most clearly seen in FIG. 1, in the present embodiment, there are four mask areas (121,122,131,132) or “pixels” to each pixel (101) of the SLM.

Returning to FIG. 2, which shows three adjacent and contiguous SLM pixels (101-103) and hence six adjacent and contiguous phase mask pixels (121-126), the first pixel (121) has a level or thickness selected to be the base thickness for the wavelength of concern and for the material of the phase mask which here is homogeneous. The second pixel (122), which is adjacent the first pixel (121), has a thickness greater than the thickness of the first pixel (121) by an amount to give an additional π/2 phase change for the wavelength of concern. The third pixel (123), which is adjacent the second pixel (122), again has the base thickness. The fourth pixel (124), which is adjacent the third pixel (123), has a thickness greater than that of the base thickness by an amount giving in use a π phase change to the wavelength of concern; the fifth pixel (125), which is adjacent the fourth pixel (124), has a thickness greater than that of the base thickness by an amount giving in use a 3π/2 phase change to the wavelength of concern. The sixth pixel (106), which is adjacent the fifth pixel (125), has the base thickness.

It will be understood that the phase mask could also be of constant thickness with each pixel phase level being achieved by different refractive indices. This may be achieved by differentially subjecting a photosensitive material in the respective phase level regions to different amounts of radiation.

It will also be understood that the underlying pixellated hologram need not be displayed on an SLM but could in fact be a permanent hologram

It has been shown that this new type of phase mask allows viewing angle to be increased by several times, providing at the same time an increase in effective resolution without any increase in required bandwidth: a phase mask of half the pitch of the hologram can approximately double the viewing angle and quadruple the number of addressable points in the replay field. These gains are however at the expense of additional noise in the replay field.

To overcome this defect reference is made to our co-pending patent application GB0329012.9 filed Dec. 15, 2003 (agents ref P36148GB) in which we describe a technique which we call OSPR which allows a very rapid calculation of a hologram for a scene. The patent application describes how perceived noise in a hologram display is reduced by displaying several independently generated sequential holograms per frame. This technique may be applied to the present noise increase to allow a high quality low perceived noise display, having a wide viewing angle.

A known holographic display, believed to be the most advanced holographic display currently in existence, exhibits a conjugate image restricting the usable display area . In addition, the small viewing angle is a significant limitation for many potential applications. Application of an embodiment of the invention, using a super-resolution four-level phase mask technique to the known display would significantly widen its commercial viability (see FIG. 4).

A test simulation was performed of a 3D display of resolution 1024×1024 with 10 μm pixels (ordinarily giving a viewing angle of 3 degrees) employing a 4096×4096 phase mask with 2.5 μm pixels, fabricated on polycarbonate, giving an enhanced viewing angle of around 14 degrees. A single hologram was calculated using OSPR (N=1) to display a 3D wireframe cube on the display.

In FIG. 3, a close-up view of the corner of the cube is shown, generated from a 1024×1024 hologram with 4096×4096 phase mask (left) and a 4096×4096 hologram with 4096×4096 phase mask (right). As can be seen, the left image is of comparable quality to the right, despite the 16-fold reduction in hologram bandwidth.

Although the embodiments described relate to a super-resolution phase mask, a same-resolution phase mask shifted by a half pixel in both directions, so that the pixel intersection of the phase mask is central or roughly central of the underlying hologram can also be used to improve viewing angle.

An embodiment of the invention has now been described. The invention however is not to be taken as limited to the features disclosed but instead extends to the full scope of the appended claims.

1. A holographic display comprising a pixellated hologram display device having a predetermined resolution and a pixellated phase mask arranged such that holograms displayed on the SLM are viewed through the phase mask, wherein the phase mask has a resolution higher than the predetermined resolution.

2. A holographic display comprising a pixellated hologram display device having a predetermined resolution and a pixellated phase mask arranged such that holograms displayed on the SLM are viewed through the phase mask, wherein the phase mask co-operates with the SLM such that the repeating pattern of holographic elements has a higher resolution than the predetermined resolution.

3. A holographic display according to claim 1 or 2 wherein the hologram display device is arranged to display binary phase holograms and the phase mask has four phase levels

4. A holographic display according to claim 3, wherein the display is constructed and arranged to operate at a given optical wavelength, and taking one of the phase levels as a reference, the others provide respective phase shifts of π/2, π and 3π/2 at the given wavelength.

5. A holographic display according to claim 1 or 2 wherein the hologram display device is arranged to display four phase holograms and the phase mask has two phase-levels.

6. A holographic display according to claim 1 or 2, wherein the hologram display device comprises an SLM.

7. A method of increasing the viewing angle of a hologram on a pixellated hologram display device having a predetermined resolution, the method comprising disposing a pixellated phase mask with respect to the pixellated hologram display device for viewing the hologram, wherein the resolution of the pixellated phase mask is greater than that of the pixellated hologram display device.

8. A method of viewing a pixellated hologram, the pixels of the hologram having a predetermined resolution, comprising viewing the hologram through a pixellated phase mask, wherein the resolution of the pixellated phase mask is greater than that of the pixellated hologram.

9. A holographic display comprising a pixellated hologram display device having a predetermined resolution and a pixellated phase mask arranged such that holograms displayed on the SLM are viewed through the phase mask, wherein the phase mask is arranged so that respective locations where its pixels meet are disposed above generally central regions of the pixels of the display device.
